(19) United States
(12) Patent Application Publication
(10) Pub. No.: US 2025/0353468 A1
(43) Pub. Date: Nov. 20, 2025

(54) WIPER BEAM BLADE ASSEMBLY WITH SUPPORT STRUCTURE

(71) Applicant: Rosemount Aerospace Inc., Burnsville, MN (US)

(72) Inventors: Venkata Anil Kumar Mothe, Karnataka (IN); Sandeep Jayaraj, Bangalore (IN); PAVAN G, Bangalore (IN); Vishwanath Hitnalli, Bangalore (IN)

(21) Appl. No.: 19/085,691

(22) Filed: Mar. 20, 2025

(30) Foreign Application Priority Data
May 20, 2024 (IN) 202411039337

(51) Int. Cl. B60S 1/34; B60S 1/38; B60S 1/40; B64C 1/14

(52) U.S. Cl. CPC B60S 1/3475; B60S 1/4083; B64C 1/14; B60S 2001/3829

(57) ABSTRACT

A wiper assembly may include a wiper blade comprising: a blade element; and a support element secured to the blade element along a blade element length of the blade element. A wiper assembly may include a flat spring coupled on a first end to a first end of the support element via a first coupling and coupled on a second end to a second end of the support element via a second coupling. A wiper assembly may include a saddle clip disposed between the first end of the support element and the second end of the support element and configured to couple the flat spring to the support element, wherein a downward biasing of the saddle clip causes the wiper assembly to bias against the windshield.

### CROSS-REFERENCE TO RELATED APPLICATION

This nonprovisional application claims the benefit of priority of Indian patent application Ser. No. 20/241,1039337 filed May 20, 2024, which is hereby incorporated by reference in its entirety.

### BACKGROUND

Aircraft windshield wiper systems are used to wipe and clean water or other debris from an aircraft windshield, allowing better visibility out the windshield for both the pilot and co-pilot. Windshield wiper systems include a wiper arm and a wiper assembly that sweeps back and forth across a windshield, cleaning the windshield for the pilot and co-pilot. The wiper arm is coupled to the wiper assembly via a coupler.

Traditionally, the wiper assembly includes a frame and a blade element, with the frame coupled to the wiper arm via a coupler. A blade load is provided by the frame at the coupler, providing a force that is distributed along the blade element. Because of the flexibility of the blade element and the curvature of windshields, the blade load induces non-uniform stress over the length of the blade element during a wiping motion, resulting in gaps between the blade element and the windshield surface.

As such, there is a need for a wiper assembly and/or blade element that induces uniform stress over the length of the blade element, and reduced gap formation than traditional wiper assemblies.

### SUMMARY

In some aspects, the techniques described herein relate to a wiper assembly for a windshield including: a wiper blade including: a blade element; and a support element secured to the blade element along a blade element length of the blade element; a flat spring coupled on a first end to a first end of the support element via a first coupling and coupled on a second end to a second end of the support element via a second coupling; and a saddle clip disposed between the first end of the support element and the second end of the support element and configured to couple the flat spring to the support element, wherein a downward biasing of the saddle clip causes the wiper assembly to bias against the windshield.

In some aspects, the techniques described herein relate to a wiper assembly, wherein a first gap between the support element and the flat spring is formed between the first coupling and the saddle clip, wherein a second gap between the support element and the flat spring is formed between the second coupling and the saddle clip.

In some aspects, the techniques described herein relate to a wiper assembly, further including a first load spacer disposed within the first gap and a second load spacer disposed within the second gap, wherein a load from the downward biasing of the saddle clip is transferred to the first coupling, the second coupling, the first load spacer, and the second load spacer.

In some aspects, the techniques described herein relate to a wiper assembly, wherein the first load spacer is secured to the support element via a first enclosure clip, wherein the second load spacer is secured to the support element via a second enclosure clip.

In some aspects, the techniques described herein relate to a wiper assembly, wherein the flat spring is retained within the first enclosure clip and the second enclosure clip.

In some aspects, the techniques described herein relate to a wiper assembly, wherein the first coupling and the second coupling include end clips.

In some aspects, the techniques described herein relate to a wiper assembly, wherein the wiper assembly includes two first load spacers disposed within the first gap and two second load spacers disposed within the second gap.

In some aspects, the techniques described herein relate to a wiper assembly, wherein the first load spacer and the second load spacer are integrated into the support element.

In some aspects, the techniques described herein relate to a wiper assembly, wherein the downward biasing produces an applied load at the first coupling and the second coupling that is greater than if the wiper assembly did not include the flat spring.

In some aspects, the techniques described herein relate to a wiper assembly, wherein the downward biasing produces an applied load at the saddle clip, the first coupling and the second coupling, wherein the applied load of at least the first coupling or the second coupling is at least 40% of the applied load produced at the saddle clip.

In some aspects, the techniques described herein relate to a wiper assembly, wherein the support element is constructed from a composite material.

In some aspects, the techniques described herein relate to a wiper assembly, wherein the support element is constructed of carbon fiber-reinforced polymer.

In some aspects, the techniques described herein relate to a wiper assembly, wherein the blade element is constructed from a rubber material.

In some aspects, the techniques described herein relate to a wiper assembly, wherein the blade element is constructed from a nitrile rubber.

In some aspects, the techniques described herein relate to a wiper assembly, wherein the wiper assembly is for use on the windshield of an aircraft.

In some aspects, the techniques described herein relate to a wiper assembly, wherein the blade element and the support element are bonded via an adhesive.

In some aspects, the techniques described herein relate to a windshield wiper system for use on a windshield of an aircraft including: a wiper assembly for a windshield including: a wiper blade including: a blade element; and a support element secured to the blade element along a blade element length of the blade element; a flat spring coupled on a first end to a first end of the support element via a first coupling and coupled on a second end to a second end of the support element via a second coupling; a saddle clip disposed between the first end of the support element and the second end of the support element and configured to couple the flat spring to the support element, wherein a downward biasing of the saddle clip causes the wiper assembly to bias against the windshield, wherein a first gap between the support element and the flat spring is formed between the first coupling and the saddle clip, wherein a second gap between the support element and the flat spring is formed between the second coupling and the saddle clip; and a first load spacer disposed within the first gap and a second load spacer disposed within the second gap, wherein a load from the downward biasing of the saddle clip is transferred to the first coupling, the second coupling, the first load spacer, and the second load spacer.

In some aspects, the techniques described herein relate to a windshield wiper system, further including a wiper arm.

In some aspects, the techniques described herein relate to a windshield wiper system, wherein the blade element is constructed from a nitrile material, wherein the support element is constructed of carbon fiber-reinforced polymer.

In some aspects, the techniques described herein relate to a method for assembling a wiper assembly including: bonding a blade element to a support element; obtaining a flat spring; coupling the flat spring to the support element via a saddle clip; coupling a first load spacer to the support element between a first end of the support element and the saddle clip; coupling a second load spacer to the support element between a second end of the support element and the saddle clip; and securing a first end of the flat spring to the first end of the support element and a second end of the flat spring to the second end of the support element.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 illustrates a cross-sectional side-view of a wiper assembly for a windshield, in accordance with one or more embodiments of the disclosure.

FIG. 2A illustrates a perspective view of the wiper assembly, in accordance with one or more embodiments of the disclosure.

FIG. 2B illustrates a partial side view of the wiper assembly, in accordance with one or more embodiments of the disclosure.

FIG. 2C illustrates a partial perspective view of the wiper assembly, in accordance with one or more embodiments of the disclosure.

FIG. 3 illustrates a cross-sectional side-view of the wiper assembly with indicated load points, in accordance with one or more embodiments of the disclosure.

FIG. 4 illustrates a cross-sectional side view of a wiper assembly with four load spacers, in accordance with one or more embodiments of the disclosure.

FIG. 5A illustrates a process flow diagram depicting a method 500 for assembling the wiper assembly 100, in accordance with one or more embodiments of the disclosure.

FIG. 5B illustrates views 550, 552, 554, and 556 corresponding to the steps of method 500, in accordance with one or more embodiments of the disclosure.

FIG. 6 illustrates a simplified view of windshield 600 and wiper system 602 in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any of the following: A is true (or present) and B is false (or not present), A is false (or not present) and B is true (or present), and both A and B are true (or present).

In addition, the use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Reference will now be made in detail to the subject matter disclosed, which is illustrated in the accompanying drawings.

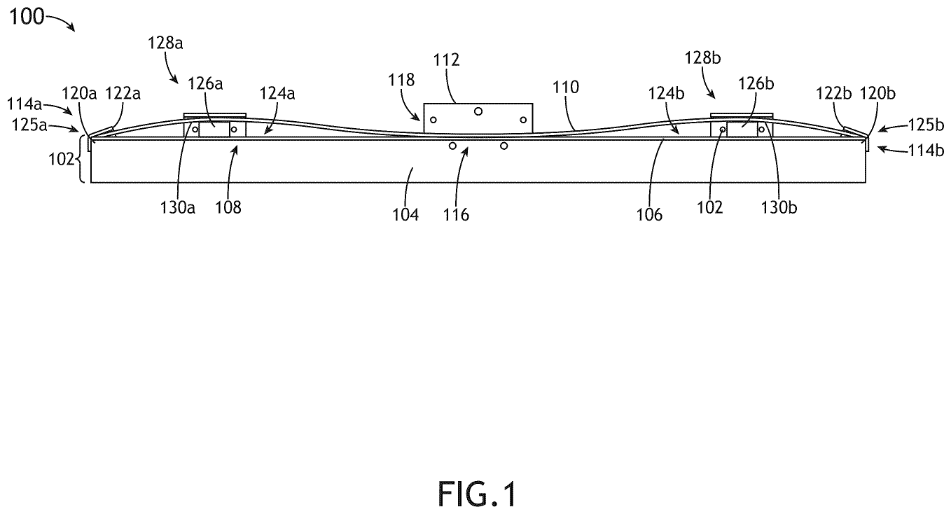

FIGS. 1-6 illustrate a wiper assembly and a method for making the wiper assembly. The wiper assembly includes a wiper blade that makes contact with the windshield, and a coupler for attaching a wiper arm to the wiper blade. The wiper assembly further includes a flat spring that is coupled to the wiper blade via a saddle clip and side clips. The flat spring is attached so that when the wiper blade is biased against the windshield via the coupler, the flat spring distributes the load placed on the coupler to multiple places along the length of the wiper blade, increasing load uniformity and decreasing the formation of gaps. The securing of the saddle clip to the flat spring also produces gaps between the flat spring and a support element of the wiper blade. Load spacers (e.g., blocks) may be placed within these gaps, which helps to distribute the load.

FIG. 1 illustrates a cross-sectional side-view of a wiper assembly 100 for a windshield, in accordance with one or more embodiments of the disclosure.

In embodiments, the wiper assembly may be used for any type of windshield, such as a vehicle windshield. For example, the wiper assembly may be used for a windshield of vehicles that include, but are not limited to, an aircraft, an automobile, a tractor, or a truck. For instance, the wiper assembly may be used for cleaning the windshield of a commercial or military aircraft. Wiper assemblies are described in U.S. Pat. No. 11,292,435, filed Feb. 28, 2019, and U.S. Pat. No. 11,685,341, filed Mar. 15, 2021, both of which are incorporated by reference in their entirety.

In embodiments, the wiper assembly 100 includes a wiper blade 102. The wiper blade 102 includes a blade element 104 that makes contact with the windshield and is configured to clear the windshield of water or other debris. The blade element 104 may include a cross-sectional shape including a rectangular top portion and a generally triangular bottom portion configured to contact and clean the windshield. In some embodiments, blade element 104 can also include necked-down portions and wider portions positioned between the rectangular top portion and the generally triangular bottom portion. The blade element 104 may be constructed from a rubber or elastic material, such as nitrile rubber or silicone.

In embodiments, the includes a support element 106 that is secured to the blade element 104 along a blade element length 108 of the blade element 104. The support element provides rigidity to the blade element 104 during the operation of the wiper assembly 100. For example, the support element may include a rectangular cross-section extending the blade element length 108, providing stiffness and rigidity to wiper blade 102 to prevent undesirable deflection of wiper blade 102 in the sweeping directions. In another embodiment, the support element 106 can include a cross-section of any shape that extends a full or partial length of the wiper blade 102. The support element 106 can be constructed from a composite material, metallic material, or polymer material. In one example, the support element 106 can be constructed from a carbon fiber-reinforced polymer. The support element 106 may be coupled to the blade element 104 through an adhesive positioned between the support element 106 and blade element 104 and extending a substantial length of the support element 106. In one example, the adhesive used to couple the support element 106 to the blade element 104 is a polyurethane adhesive.

In embodiments, the wiper assembly 100 includes a flat spring 110 (e.g., a spine support) that is coupled to the support element 106 via a saddle clip 112 and end clips 114a-b. The flat spring 110 distributes the load placed upon the saddle clip 112 by a wiper arm to multiple positions along the wiper blade 102 (e.g., wherein a downward biasing of the saddle clip 112 by the wiper arm causes the wiper blade 102 and/or wiper assembly 100 to bias against the windshield. The flat spring can be made from a metallic or non-metallic material.

The saddle clip 112 is positioned or disposed at a center position with respect to the blade element length 108. And extends outward from the support element 106 in a direction opposite of the blade element 104. The saddle includes a lower attachment 116 for securing the flat spring 110 to the support element 106 and an upper attachment site 118 for coupling to the wiper arm. The end clips 114a-b couple a first end 120a of the support element 106 to a first end 122a of the flat spring 110 and couple a second end 120b of the support element 106 to a second end 122b of the flat spring 110. The saddle clip 112, end clips 114a-b, enclosure clips 128a-b and other componentry may be fastened to the wiper assembly by any fasteners or fastening means including, but not limited to, interference fit, screws, rivets (e.g., hollow rivets, standard rivets), bolt and nut, pin and clevis, and pin and clamp or any joining method. Joining methods may include, but not be limited to, welding and brazing.

In embodiments, the attachment of the flat spring 110 to the support element 106 produces one or more gaps 124a-b. For example, the wiper assembly 100 may include a first gap 124a formed between the support element 106 and the flat spring 110 that is bounded by the coupling of the first end 122a of the flat spring 110 to the first end 120a of the support element 106 (e.g., a first coupling 125a) and a second gap 124b formed between the support element 106 and the flat spring 110 that is bounded by the coupling of the second end 122b of the flat spring 110 to the second end 120b of the support element 106 (e.g., a second coupling 125b). The formation of the gaps 124a-b correlates to the distribution of load to the first end 120a and second end 120b of the support element 106.

In embodiments, The wiper assembly 100 includes load spacers 126a-b that are positioned or disposed within the gaps 124a-b. The load spacers 126a-b may be constructed from metal or nonmetal material and may take any form including, but not limited to, a block or a spring. The load spacers 126a-b may be attached to the wiper blade 102 via enclosure clips 128a-b or may be integrated into the support element 106. The load spacers 126a-b are biased by the flat spring 110 when a load is placed upon the saddle clip 112. The load spacers 126a-b and or enclosure clip 128a-b may include guides 130a-b that align the flat spring 110 with the load spacers 126a-b to ensure that the flat spring 110 bias against the load spacers 126a-b when the loading force is applied to the saddle clip 112. The wiper assembly 100 may include any number of load spacers, enclosure clips & fasteners (e.g., 2, 4, and 6). The width of the load spacer 126 may be adjusted to accommodate different lengths of the wiper assembly 100 and associated gaps 124a-b.

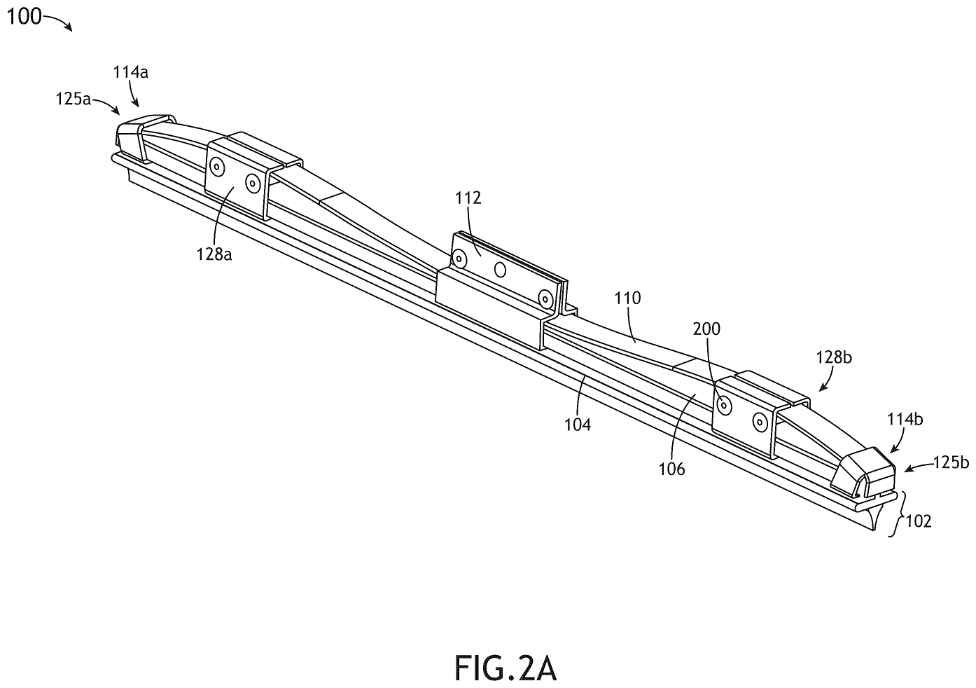

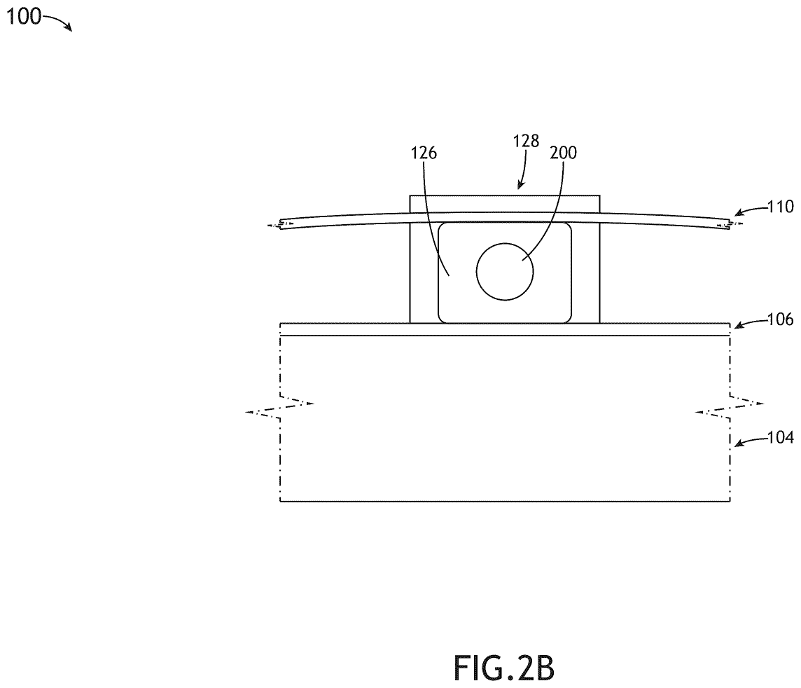

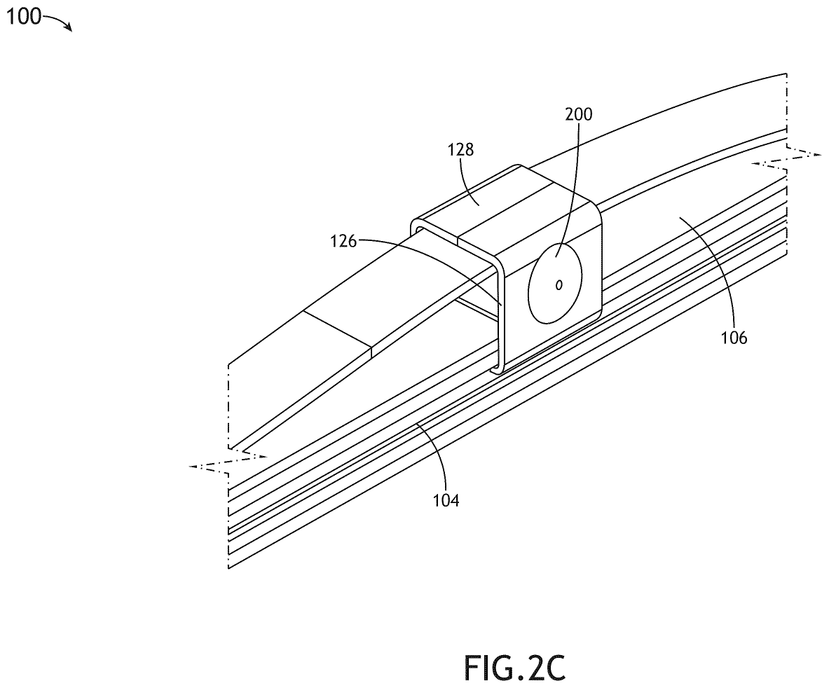

FIG. 2A illustrates a perspective view of the wiper assembly 100, in accordance with one or more embodiments of the disclosure. The load spacers 126a-b are hidden from view via the enclosure clips 128a-b. The enclosure clips 128a-b are shown as being clamped to the wiper blade 102 via rivets 200. However, other methods for coupling the enclosure clips 128a-b to the wiper blade 102 may be used. The flat spring 110 is constrained or retained by the saddle clip 112, the end clips 114a-b, and the enclosure clips 128a-b, however, the saddle clip 112, the end clips 114a-b, and the enclosure clips 128a-b may allow some movement by the flat spring 110 as the flat spring 110 adjusts to increased load.

FIGS. 2B to 2C illustrate partial side and perspective views, respectively, of the wiper assembly 100, in accordance with one or more embodiments of the disclosure. In embodiments, one or more rivets 200 may pass through both the load spacer 126 and the enclosure clip 128.

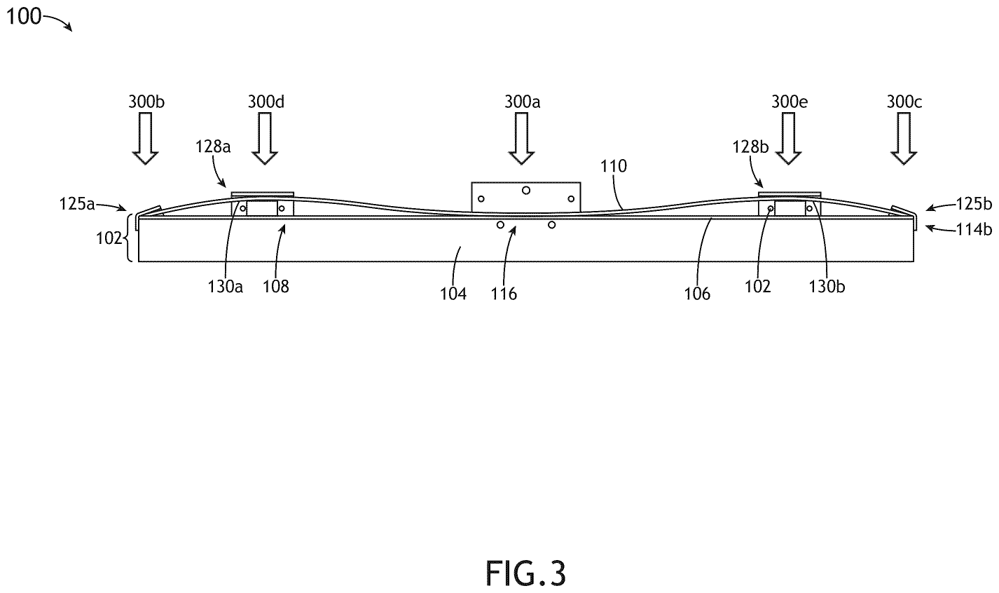

FIG. 3 illustrates a cross-sectional side view of the wiper assembly 100 with indicated load points 300a-e, in accordance with one or more embodiments of the disclosure.

In embodiments, the load applied to the saddle clip 112 is distributed through the blade element length 108 via the flat spring 110. For example, the initial load by the wiper arm biases the saddle clip 112 at load point 300a. A portion of the load is then distributed or transferred to the ends of the flat spring 110 (e.g., the first coupling 125a and the second coupling 125b) at load points 300b-c (e.g., an applied load). If the wiper assembly 100 includes load spacers, 126a-b, then a portion of the load is also distributed to load points 300d-e. In this manner, the load is distributed throughout the blade element length 108, reducing the formation of gaps and spaces between the blade element 104 and the windshield when the wiper blade 102 is in use. The load at the ends (e.g., load points 300d-e) may be proportional to a length, a width, a thickness, or a curvature of the flat spring 110. The load at the ends may also be proportional or otherwise be affected by the material of the flat spring 110

In embodiments, the load (e.g., downward biasing) at the first coupling 125a and the second coupling 125b (e.g., the end tips of the flat spring) is greater than 40% of the applied load (e.g., as applied to the saddle clip 112. In embodiments, the load at the first coupling 125a and the second coupling 125b is greater than 50% of the applied load. In embodiments, the load at the first coupling 125a and the second coupling 125b is greater than 60% of the applied load. In embodiments, the load at the first coupling 125a and the second coupling 125b is approximately 50% of the applied load. In embodiments, downward biasing transferred to the first coupling 125a and the second coupling 125b from the saddle clip 112 is greater than a wiper assembly 100 that does not include the flat spring 110.

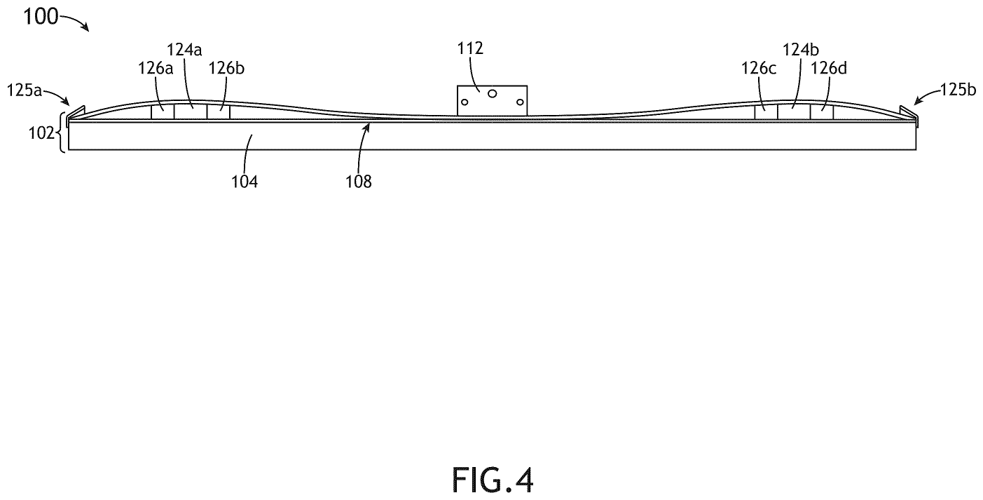

FIG. 4 illustrates a cross-sectional side view of a wiper assembly 100 with four load spacers 128a-d, along with respective enclosure clips and fasteners in accordance with one or more embodiments of the disclosure. For example, the wiper assembly 100 may include two load spacers 126a-b positioned at a first gap 124a, and two load spacers 126c-d positioned at a second gap 124b.

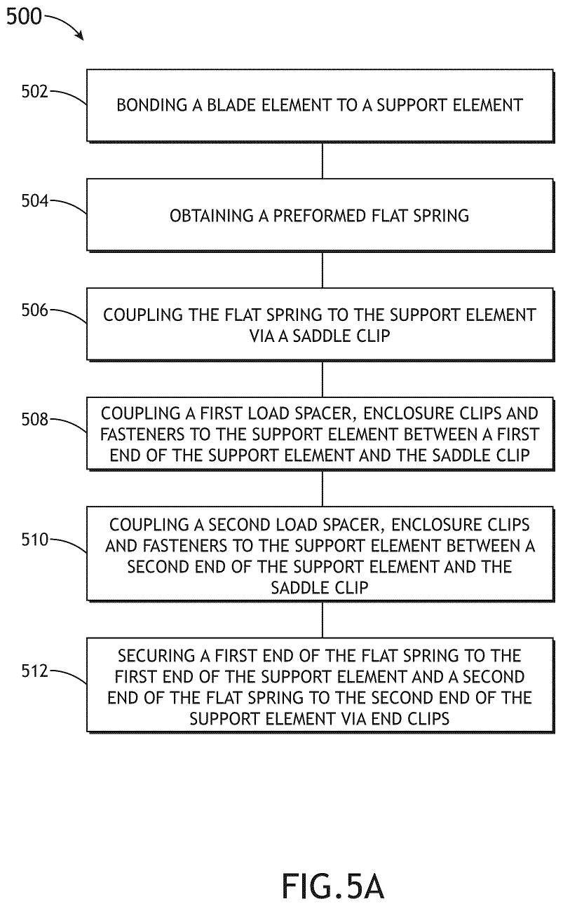

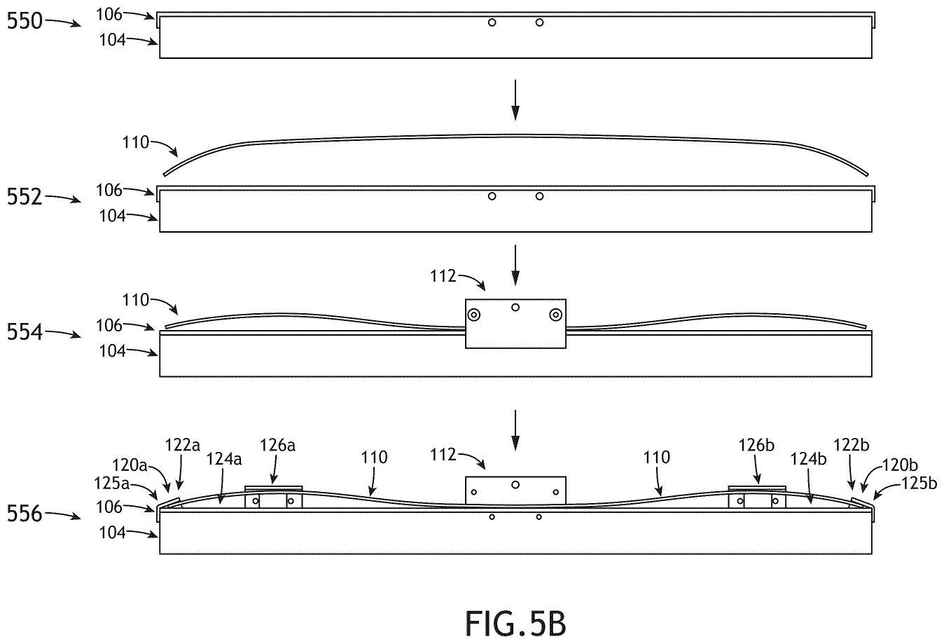

FIG. 5A illustrates a process flow diagram depicting a method 500 for assembling the wiper assembly 100, in accordance with one or more embodiments of the disclosure.

FIG. 5B illustrates views 550, 552, 554, and 556 corresponding to the steps of method 500, in accordance with one or more embodiments of the disclosure. In embodiments, the method 500 includes a step 502 of bonding the blade element 104 to the support element 106, as depicted in view 550. For example, the bonding may include the use of an adhesive.

In embodiments, the method 500 includes a step 504 of obtaining a preformed flat spring 110, as depicted in view 552. For example, flat spring 110 may include a preformed curve that will flatten out when secured to the support element 106 by the saddle clip 112. When flattened, the flat spring 110 may provide an initial biasing force at the first coupling 125a and the second coupling 125b.

In embodiments, the method 500 includes a step 506 of coupling the flat spring 110 to the support element 106 via the saddle clip 112, as depicted in view 554. For example, the saddle clip 112 may secure the flat spring to the support element 106 via rivets. In embodiments, the method 500 may include a step 508 of coupling a first load spacer 126a and enclosure clip 128a to the support element 106 at a point between a first end 120a of the support element 106 and the saddle clip 112. In embodiments, the method 500 may include a step 510 of coupling a second load spacer 126b and enclosure clip 128b to the support element 106 at a point between a second end 120b of the support element 106 and the saddle clip 112. Steps 508, 510 are depicted in view 556.

In embodiments, the method 500 may include a step 512 of securing the first end 122a of the flat spring 110 to the first end 120a of the support element (e.g., creating a first coupling 125a) and a second end 122b of the flat spring 110 to the second end 120b of the support element 106 (e.g., creating a second coupling 125b), as depicted in view 556. For example, the ends of the flat spring 110 may be secured to the ends of the support element 106 via end clips 114a-b.

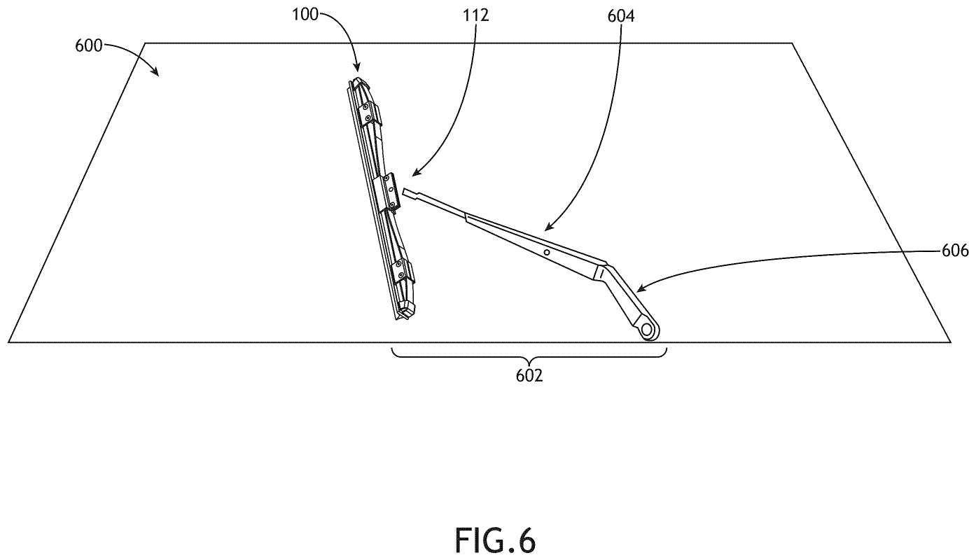

FIG. 6 illustrates a simplified view of windshield 600 and wiper system 602 in accordance with one or more embodiments of the disclosure. The wiper system 602 includes the wiper assembly 100 and a wiper arm 604 coupled to the wiper assembly 100 via the saddle clip 112. The wiper arm 604 supplies a load to the saddle clip 112, biasing the wiper assembly 100 toward the windshield 600. The wiper arm 604 also articulates the wiper assembly 100 along the surface of the windshield 600 in a wiping motion. The biasing force by the wiper arm 604 toward the windshield is typically supplied by a spring or other biasing device (not shown). The articulating motion by the wiper arm 604 is typically supplied to a motor (not shown) operatively coupled to the wiper arm 604 at a motor arm joint 606.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A wiper assembly for a windshield comprising:
a wiper blade comprising:
a blade element; and
a support element secured to the blade element along a blade element length of the blade element;
a flat spring coupled on a first end to a first end of the support element via a first coupling and coupled on a second end to a second end of the support element via a second coupling; and
a saddle clip disposed between the first end of the support element and the second end of the support element and configured to couple the flat spring to the support element, wherein a downward biasing of the saddle clip causes the wiper assembly to bias against the windshield.

2. The wiper assembly of claim 1, wherein a first gap between the support element and the flat spring is formed between the first coupling and the saddle clip, wherein a second gap between the support element and the flat spring is formed between the second coupling and the saddle clip.

3. The wiper assembly of claim 2, further comprising a first load spacer disposed within the first gap and a second load spacer disposed within the second gap, wherein a load from the downward biasing of the saddle clip is transferred to the first coupling, the second coupling, the first load spacer, and the second load spacer.

4. The wiper assembly of claim 3, wherein the first load spacer is secured to the support element via a first enclosure clip, wherein the second load spacer is secured to the support element via a second enclosure clip.

5. The wiper assembly of claim 4, wherein the flat spring is retained within the first enclosure clip and the second enclosure clip.

6. The wiper assembly of claim 1, wherein the first coupling and the second coupling comprise end clips.

7. The wiper assembly of claim 2, wherein the wiper assembly comprises two first load spacers disposed within the first gap and two second load spacers disposed within the second gap.

8. The wiper assembly of claim 3, wherein the first load spacer and the second load spacer are integrated into the support element.

9. The wiper assembly of claim 1, wherein the downward biasing produces an applied load at the first coupling and the second coupling that is greater than if the wiper assembly did not include the flat spring.

10. The wiper assembly of claim 1, wherein the downward biasing produces an applied load at the saddle clip, the first coupling and the second coupling, wherein the applied load of at least the first coupling or the second coupling is at least 40% of the applied load produced at the saddle clip.

11. The wiper assembly of claim 1, wherein the support element is constructed from a composite material.

12. The wiper assembly of claim 11, wherein the support element is constructed of carbon fiber-reinforced polymer.

13. The wiper assembly of claim 1, wherein the blade element is constructed from a rubber material.

14. The wiper assembly of claim 13, wherein the blade element is constructed from a nitrile rubber.

15. The wiper assembly of claim 1, wherein the wiper assembly is for use on the windshield of an aircraft.

16. The wiper assembly of claim 1, wherein the blade element and the support element are bonded via an adhesive.

17. A windshield wiper system for use on a windshield of an aircraft comprising:
a wiper assembly for a windshield comprising:
a wiper blade comprising:
a blade element; and
a support element secured to the blade element along a blade element length of the blade element;
a flat spring coupled on a first end to a first end of the support element via a first coupling and coupled on a second end to a second end of the support element via a second coupling;
a saddle clip disposed between the first end of the support element and the second end of the support element and configured to couple the flat spring to the support element, wherein a downward biasing of the saddle clip causes the wiper assembly to bias against the windshield, wherein a first gap between the support element and the flat spring is formed between the first coupling and the saddle clip, wherein a second gap between the support element and the flat spring is formed between the second coupling and the saddle clip; and
a first load spacer disposed within the first gap and a second load spacer disposed within the second gap, wherein a load from the downward biasing of the saddle clip is transferred to the first coupling, the second coupling, the first load spacer, and the second load spacer.

18. The windshield wiper system of claim 17, further comprising a wiper arm.

19. The windshield wiper system of claim 17, wherein the blade element is constructed from a nitrile material, wherein the support element is constructed of carbon fiber-reinforced polymer.

20. A method for assembling a wiper assembly comprising:
bonding a blade element to a support element;
obtaining a flat spring;
coupling the flat spring to the support element via a saddle clip;
coupling a first load spacer to the support element between a first end of the support element and the saddle clip;
coupling a second load spacer to the support element between a second end of the support element and the saddle clip; and
securing a first end of the flat spring to the first end of the support element and a second end of the flat spring to the second end of the support element.
